(19) United States
(12) Patent Application Publication
(10) Pub. No.: US 2017/0292179 A1
(43) Pub. Date: Oct. 12, 2017

(54) HIGH TEMPERATURE, RADIATION-RESISTANT, FERRITIC-MARTENSITIC STEELS

(71) Applicant: TerraPower, LLC, Bellevue, WA (US)

(72) Inventor: Micah J. Hackett, Seattle, WA (US)

(73) Assignee: TerraPower, LLC, Bellevue, WA (US)

(21) Appl. No.: 15/484,001

(22) Filed: Apr. 10, 2017

Related U.S. Application Data
(60) Provisional application No. 62/321,066, filed on Apr. 11, 2016.

(51) Int. Cl. C22C 38/54; C22C 38/48; C22C 38/46; G21C 3/07; C22C 38/04; C22C 38/02; C22C 38/00; G21F 1/08; C22C 38/50; C22C 38/44

(52) U.S. Cl. CPC C22C 38/54; C22C 38/50; C22C 38/48; C22C 38/46; C22C 38/44; C22C 38/04; C22C 38/02; C22C 38/001; G21F 1/08; G21C 3/07; G21Y 2004/10

(57) ABSTRACT

This disclosure describes new high temperature, radiation-resistant, ferritic-martensitic steel compositions. The new steels generally contain 9.0-12.0 wt. % Cr, 0.001-1.0 wt. % Mn, 0.001-2.0 wt. % Mo, 0.001-2.5 wt. % W, and 0.1-0.3 wt. % C, with the balance being primarily Fe. More specifically, steels having from 10.0-12.0 wt. % Cr are considered particularly advantageous. Small amounts of N, Nb, V, Ta, Ti, Zr, and B may or may not also be present, depending on the particular embodiment. Impurities may be present in any embodiment, in particular impurities of less than 0.01 wt. % S, less than 0.04 wt. % P, less than 0.04 wt. % Cu, less than 0.05 wt. % Co, and less than 0.03 wt. % As are contemplated. Examples of these steels exhibit improved fracture toughness and reduced thermal creep and swelling.

### RELATED APPLICATIONS

This application claims the benefit of U.S. Provisional Application No. 62/321,066, filed Apr. 11, 2016, which application is hereby incorporated by reference.

### INTRODUCTION

Steel refers to alloys of iron and carbon that are useful in a variety of applications. A great deal of work has been done over the last 50 years to develop new, higher temperature ferritic-martensitic steels. The primary use is in industry for condenser and boiler tubes. Steel has also seen some use in the nuclear power industry in sodium fast reactors. The last 30 years of development has focused primarily on versions of steel with 8-9 wt. % Cr. While a large number of steels have been developed, very few have become commercially viable.

High Temperature, Radiation-Resistant, Ferritic-Martensitic Steels

This disclosure describes new high temperature, radiation-resistant, ferritic-martensitic steel compositions. The new steels generally contain 9.0-12.0 wt. % Cr, 0.001-1.0 wt. % Mn, 0.001-2.0 wt. % Mo, 0.001-2.5 wt. % W, and 0.1-0.3 wt. % C, with the balance being primarily Fe. More specifically, steels having from 10.0-12.0 wt. % Cr are considered particularly advantageous. Small amounts of N, Nb, V, Ta, Ti, Zr, and B may or may not also be present, depending on the particular embodiment. Impurities may be present in any embodiment, in particular impurities of less than 0.01 wt. % S, less than 0.04 wt. % P, less than 0.04 wt. % Cu, less than 0.05 wt. % Co, and less than 0.03 wt. % As are contemplated. Examples of these steels exhibit improved fracture toughness and reduced thermal creep and swelling.

These and various other features as well as advantages which characterize the steel compositions and methods described herein will be apparent from a reading of the following detailed description and a review of the associated drawings. Additional features are set forth in the description which follows, and in part will be apparent from the description, or may be learned by practice of the technology. The benefits and features of the technology will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which form a part of this application, are illustrative of described technology and are not meant to limit the scope of the invention as claimed in any manner, which scope shall be based on the claims appended hereto.

FIG. 1 lists some nominal embodiments of ferritic-martensitic steels subjected to thermodynamic analysis.

FIG. 2 illustrates various components of an embodiment of a nuclear reactor, in this case a traveling wave reactor, for which the high-temperature, radiation resistance ferritic-martensitic steels could be utilized.

FIG. 3 lists ferritic-martensitic steels selected for further study of precipitate phases.

FIGS. 4A and 4B are sample results from the precipitate phase study.

FIGS. 5A-5D illustrate results of additional thermodynamic calculations on various steel embodiments.

FIGS. 6A-6L are thermodynamic predictions for different embodiments of the steel as described herein.

FIG. 7A provides partial-cutaway perspective views in schematic form of an embodiment of a nuclear fuel assembly comprised of multiple fuel elements.

FIG. 7B provides a partial illustration of a fuel element.

FIG. 7C illustrates an embodiment of a fuel element in which one or more liners are provided between the cladding and the fuel.

FIG. 8 illustrates a shell and tube heat exchanger configured with a shell.

FIG. 9 illustrates embodiments of open, semi-open and closed impellers.

FIG. 10 illustrates several fasteners which could be made of the embodiments of ferritic-martensitic steels described herein.

FIG. 11 presents the compositions of fabricated embodiments of ferritic-martensitic steels described herein.

FIG. 12 presents the creep rupture test results of the embodiments listed in FIG. 11.

### DETAILED DESCRIPTION

This disclosure describes new high temperature, radiation-resistant, ferritic-martensitic steel compositions. The new steels generally contain 9.0-12.0 wt. % Cr, 0.001-1.0 wt. % Mn, 0.001-2.0 wt. % Mo, 0.001-2.5 wt. % W, and 0.1-0.3 wt. % C, with the balance being primarily Fe. More specifically, steels having from 10.0-12.0 wt. % Cr are considered particularly advantageous. Small amounts of N, Nb, V, Ta, Ti, Zr, and B may or may not also be present, depending on the particular embodiment. Impurities may be present in any embodiment, in particular impurities of less than 0.01 wt. % S, less than 0.04 wt. % P, less than 0.04 wt. % Cu, less than 0.05 wt. % Co, and less than 0.03 wt. % As are contemplated.

Before the new ferritic-martensitic steels are disclosed and described in further detail, it is to be understood that terminology employed herein is used for the purpose of describing particular embodiments only and is not intended to be limiting. It must be noted that, as used in this disclosure, the singular forms “a,” “an,” and “the” include plural referents unless the context clearly dictates otherwise. Thus, for example, reference to “a lithium hydroxide” is not to be taken as quantitatively or species limiting, reference to “a step” may include multiple steps, reference to “producing” or “products” of a reaction should not be taken to be all of the products of a reaction, and reference to “reacting” may include reference to one or more of such reaction steps. As such, the step of reacting can include multiple or repeated reaction of similar materials to produce identified reaction products.

The new steel compositions described herein have been identified as having improved performance at high temperatures (i.e., above 500° C. and particularly from 550 to 750° C.) and in a radioactive environment, such as in or near a reactor core of a nuclear reactor. Embodiments of the new steels contain from 9.0 to 12 wt. % Cr, 0.001-1.0 wt. % Mn, 0.001-2.0 wt. % Mo, 0.001-2.5 wt. % W, and 0.1-0.3 wt. % C. In particular, it is believed that embodiments having from 10.0 to 12.0 wt. % Cr, 0.2-0.8 wt. % Mn, 0.2-1.0 wt. % Mo, 0.5-1.5 wt. % W, and 0.15-0.25 wt. % C will exhibit improved creep strength, fracture toughness, and swelling resistance at high temperatures and that embodiments having from 10.5 to 11.5 wt. % Cr, 0.4-0.6 wt. % Mn, 0.25-0.35 wt. % Mo, 0.9-1.1 wt. % W, and 0.18-0.22 wt. % C may exhibit the best high temperature performance. Small amounts of N, Nb, V, Ta, Ti, Zr, and B may or may not also be present, depending on the particular steel embodiment.

Tables 1 and 2 are a non-exhaustive list of embodiments of the new high temperature, radiation-resistant, ferritic-martensitic steel compositions (all amounts in wt. % with the balance being iron and impurities, if any). Steels #A1-A3 are different ranges representing different groups of embodiments. Steels #A4-A9 and #B1-B8 also provide ranges describing more specific embodiments with ranges of trace elements such as N, Nb, V, Ta, Ti, Zr, and B. Steels #A10-A15 and #B9-B16 are nominal embodiments of steels with different amounts of N, Nb, V, Ta, Ti, Zr, and B.

TABLE 1
REPRESENTATIVE STEEL EMBODIMENTS

| Steel # | Cr | Mn | Mo | W | C | N |
|---|---|---|---|---|---|---|
| A1 | 9.0-12 | 0.001-1.0 | 0.001-2.0 | 0.001-2.5 | 0.1-0.3 | 0-0.1 |
| A2 | 10.0-12.0 | 0.20-0.80 | 0.20-1.0 | 0.50-1.5 | 0.15-0.25 | 0.01-0.08 |
| A3 | 10.5-11.5 | 0.40-0.60 | 0.25-0.35 | 0.90-1.1 | 0.18-0.22 | 0.03-0.05 |
| A4 | 10.5-11.5 | 0.4-0.6 | 0.25-0.35 | 0.9-1.1 | 0.18-0.22 | 0.03-0.05 |
| A5 | 10.5-11.5 | 0.4-0.6 | 0.25-0.35 | 0.9-1.1 | 0.18-0.22 | 0.03-0.05 |
| A6 | 10.5-11.5 | 0.4-0.6 | 0.25-0.35 | 0.9-1.1 | 0.18-0.22 | 0.03-0.05 |
| A7 | 10.5-11.5 | 0.4-0.6 | 0.25-0.35 | 0.9-1.1 | 0.18-0.22 | 0.03-0.05 |
| A8 | 10.5-11.5 | 0.4-0.6 | 0.25-0.35 | 0.9-1.1 | 0.18-0.22 | 0.03-0.05 |
| A9 | 10.5-11.5 | 0.4-0.6 | 0.25-0.35 | 0.9-1.1 | 0.18-0.22 | 0.03-0.05 |
| A10 | 11 | 0.5 | 0.3 | 1 | 0.2 | 0.04 |
| A11 | 11 | 0.5 | 0.3 | 1 | 0.2 | 0.04 |
| A12 | 11 | 0.5 | 0.3 | 1 | 0.2 | 0.04 |
| A13 | 11 | 0.5 | 0.3 | 1 | 0.2 | 0.04 |
| A14 | 11 | 0.5 | 0.3 | 1 | 0.2 | 0.04 |
| A15 | 11 | 0.5 | 0.3 | 1 | 0.2 | 0.04 |

REPRESENTATIVE STEEL EMBODIMENTS

| Steel # | Nb | V | Ta | Ti | Zr | B |
|---|---|---|---|---|---|---|
| A1 | 0-0.5 | 0-0.5 | 0-0.3 | 0-0.5 | 0-0.5 | 0-0.1 |
| A2 | 0.02-0.20 | 0.10-0.50 | 0.01-0.20 | 0.05-0.30 | 0.05-0.30 | 0.001-0.02 |
| A3 | 0.08-0.12 | 0.28-0.32 | 0.04-0.06 | 0.18-0.22 | 0.18-0.22 | 0.008-0.012 |
| A4 | <0.01 | <0.01 | <0.01 | <0.01 | <0.01 | <0.01 |
| A5 | 0.08-0.12 | 0.13-0.17 | <0.01 | 0.18-0.22 | <0.01 | 0.008-0.012 |
| A6 | 0.03-0.07 | 0.13-0.17 | 0.04-0.06 | 0.08-0.12 | 0.08-0.12 | 0.008-0.012 |
| A7 | 0.08-0.12 | 0.13-0.17 | <0.01 | 0.18-0.22 | 0.18-0.22 | 0.008-0.012 |
| A8 | 0.08-0.12 | 0.13-0.17 | 0.04-0.06 | 0.18-0.22 | 0.18-0.22 | 0.008-0.012 |
| A9 | 0.08-0.12 | 0.28-0.32 | 0.04-0.06 | 0.18-0.22 | 0.18-0.22 | 0.008-0.012 |
| A10 | 0 | 0 | 0 | 0 | 0 | 0 |
| A11 | 0.1 | 0.15 | 0 | 0.2 | 0 | 0.01 |
| A12 | 0.05 | 0.15 | 0.05 | 0.1 | 0.1 | 0.01 |
| A13 | 0.1 | 0.15 | 0 | 0.2 | 0.2 | 0.01 |
| A14 | 0.1 | 0.15 | 0.05 | 0.2 | 0.2 | 0.01 |
| A15 | 0.1 | 0.30 | 0.05 | 0.2 | 0.2 | 0.01 |

TABLE 2
REPRESENTATIVE STEEL EMBODIMENTS

| Steel # | Cr | Mn | Mo | W | Si | C | N |
|---|---|---|---|---|---|---|---|
| B1 | 10.0-11.0 | 0.5-0.7 | 0.45-0.55 | 0.9-1.1 | 0.10-0.20 | 0.18-0.22 | 0.03-0.05 |
| B2 | 10.0-11.0 | 0.5-0.7 | 0.45-0.55 | 0.9-1.1 | 0.10-0.20 | 0.18-0.22 | 0.03-0.05 |
| B3 | 10.0-11.0 | 0.5-0.7 | 0.45-0.55 | 0.9-1.1 | 0.10-0.20 | 0.18-0.22 | 0.03-0.05 |
| B4 | 10.0-11.0 | 0.5-0.7 | 0.45-0.55 | 0.9-1.1 | 0.10-0.20 | 0.18-0.22 | 0.03-0.05 |
| B5 | 10.0-11.0 | 0.5-0.7 | 0.45-0.55 | 0.9-1.1 | 0.10-0.20 | 0.18-0.22 | 0.03-0.05 |
| B6 | 10.0-11.0 | 0.5-0.7 | 0.45-0.55 | 0.9-1.1 | 0.10-0.20 | 0.18-0.22 | 0.03-0.05 |
| B7 | 10.0-11.0 | 0.5-0.7 | 0.45-0.55 | 0.9-1.1 | 0.10-0.20 | 0.18-0.22 | 0.03-0.05 |
| B8 | 10.0-11.0 | 0.5-0.7 | 0.45-0.55 | 0.9-1.1 | 0.10-0.20 | 0.18-0.22 | 0.03-0.05 |
| B9 | 10.5 | 0.6 | 0.5 | 1 | 0.1 | 0.2 | 0.04 |
| B10 | 10.5 | 0.6 | 0.5 | 1 | 0.1 | 0.2 | 0.04 |
| B11 | 10.5 | 0.6 | 0.5 | 1 | 0.1 | 0.2 | 0.04 |
| B12 | 10.5 | 0.6 | 0.5 | 1 | 0.1 | 0.2 | 0.04 |
| B13 | 10.5 | 0.6 | 0.5 | 1 | 0.1 | 0.2 | 0.04 |
| B14 | 10.5 | 0.6 | 0.5 | 1 | 0.1 | 0.2 | 0.04 |
| B15 | 10.5 | 0.6 | 0.5 | 1 | 0.1 | 0.2 | 0.04 |
| B16 | 10.5 | 0.6 | 0.5 | 1 | 0.1 | 0.2 | 0.04 |

REPRESENTATIVE STEEL EMBODIMENTS

| Steel # | Nb | V | Ta | Ti | Zr | B |
|---|---|---|---|---|---|---|
| B1 | 0.03-0.07 | 0.13-0.17 | <0.01 | <0.01 | <0.01 | 0.007-0.009 |
| B2 | 0.03-0.07 | 0.13-0.17 | 0.05-0.10 | <0.01 | <0.01 | 0.007-0.009 |
| B3 | 0.03-0.07 | 0.13-0.17 | <0.01 | 0.05-0.10 | <0.01 | 0.007-0.009 |
| B4 | 0.03-0.07 | 0.13-0.17 | <0.01 | <0.01 | 0.05-0.10 | 0.007-0.009 |
| B5 | 0.03-0.07 | 0.13-0.17 | 0.05-0.10 | 0.05-0.10 | 0.05-0.10 | 0.007-0.009 |
| B6 | <0.01 | 0.13-0.17 | <0.01 | 0.05-0.10 | 0.05-0.10 | 0.007-0.009 |
| B7 | <0.01 | 0.13-0.17 | 0.05-0.10 | 0.05-0.10 | 0.05-0.10 | 0.007-0.009 |
| B8 | <0.01 | 0.28-0.32 | 0.05-0.10 | 0.05-0.10 | 0.05-0.10 | 0.007-0.009 |
| B9 | 0.05 | 0.15 | 0 | 0 | 0 | 0.008 |
| B10 | 0.05 | 0.15 | 0.075 | 0 | 0 | 0.008 |
| B11 | 0.05 | 0.15 | 0 | 0.075 | 0 | 0.008 |
| B12 | 0.05 | 0.15 | 0 | 0 | 0.075 | 0.008 |
| B13 | 0.05 | 0.15 | 0.075 | 0.075 | 0.075 | 0.008 |
| B14 | 0 | 0.15 | 0 | 0.075 | 0.075 | 0.008 |
| B15 | 0 | 0.15 | 0.075 | 0.075 | 0.075 | 0.008 |
| B16 | 0 | 0.30 | 0.075 | 0.075 | 0.075 | 0.008 |

Impurities, in the form of elements not explicitly listed in an embodiment, may be present in any embodiment. Steel embodiments as described herein may have a total impurity concentration that does not exceed 0.35 wt %. For example, for any of the embodiments described herein or listed in Tables 1 and 2, impurities of less than 0.01 wt. % S, less than 0.04 wt. % P, less than 0.04 wt. % Cu, less than 0.05 wt. % Co, and less than 0.03 wt. % As are contemplated. Ni may also be considered an impurity and Ni values of less than 0.05 wt. % are contemplated. Note that “0” in Tables 1 and 2 should be read as being less than a detectable amount and not as an absolute absence of the element.

Steels #A2-A15 and #B1-B16 in Tables 1 and 2 are example embodiments within the general embodiment identified in Steel #A1. As mentioned above, Tables 1 and 2 are not an exhaustive list of all possible embodiments, but only a list of some representative embodiments.

Regarding N, embodiments having up to 0.1 wt. % N are contemplated. In particular, embodiments having from 0.001, 0.005, or even 0.01 wt % N up to as much as 0.05 to 0.1 wt % N are contemplated (e.g., that means that from 0.001-0.05 wt % N; 0.005-0.1 wt % N, 0.01-0.05 wt % N are all embodiments of the steel).

Regarding Nb, embodiments having up to 0.5 wt. % Nb are contemplated. In particular, embodiments having from 0.001, 0.005, or even 0.01 wt % Nb up to as much as 0.05, 0.1, 0.2, or even 0.5 wt % Nb are contemplated.

Regarding V, embodiments having up to 0.5 wt. % V are contemplated. In particular, embodiments having from 0.001, 0.005, or even 0.01 wt % V up to as much as 0.05, 0.1, 0.2, or even 0.5 wt % V are contemplated.

Regarding Ta, embodiments having up to 0.3 wt. % Ta are contemplated. In particular, embodiments having from 0.001, 0.005, or even 0.01 wt % Ta up to as much as 0.05, 0.1, 0.2, or even 0.3 wt % Ta are contemplated.

Regarding Ti, embodiments having up to 0.5 wt. % Ti are contemplated. In particular, embodiments having from 0.001, 0.005, or even 0.01 wt % Ti up to as much as 0.05, 0.1, 0.3, or even 0.5 wt % Ti are contemplated.

Regarding Si, embodiments having up to 0.2 wt. % Si are contemplated. In particular, embodiments having from 0.001, 0.005, or even 0.01 wt % Si up to as much as 0.05, 0.1, or even 0.2 wt % Si are contemplated.

Regarding Zr, embodiments having up to 0.5 wt. % Zr are contemplated. In particular, embodiments having from 0.001, 0.005, or even 0.01 wt % Zr up to as much as 0.05, 0.1, 0.3, or even 0.5 wt % Zr are contemplated.

Regarding B, embodiments having up to 0.012 wt. % B are contemplated. In particular, embodiments having from 0.001, 0.005, 0.007, or even 0.008 wt % B up to as much as 0.005, 0.007, 0.009, 0.010 to 0.012 wt % B are contemplated.

### EXAMPLES

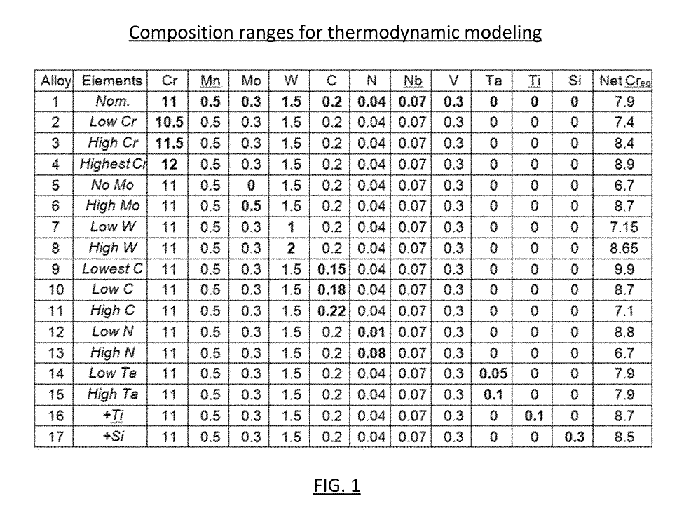

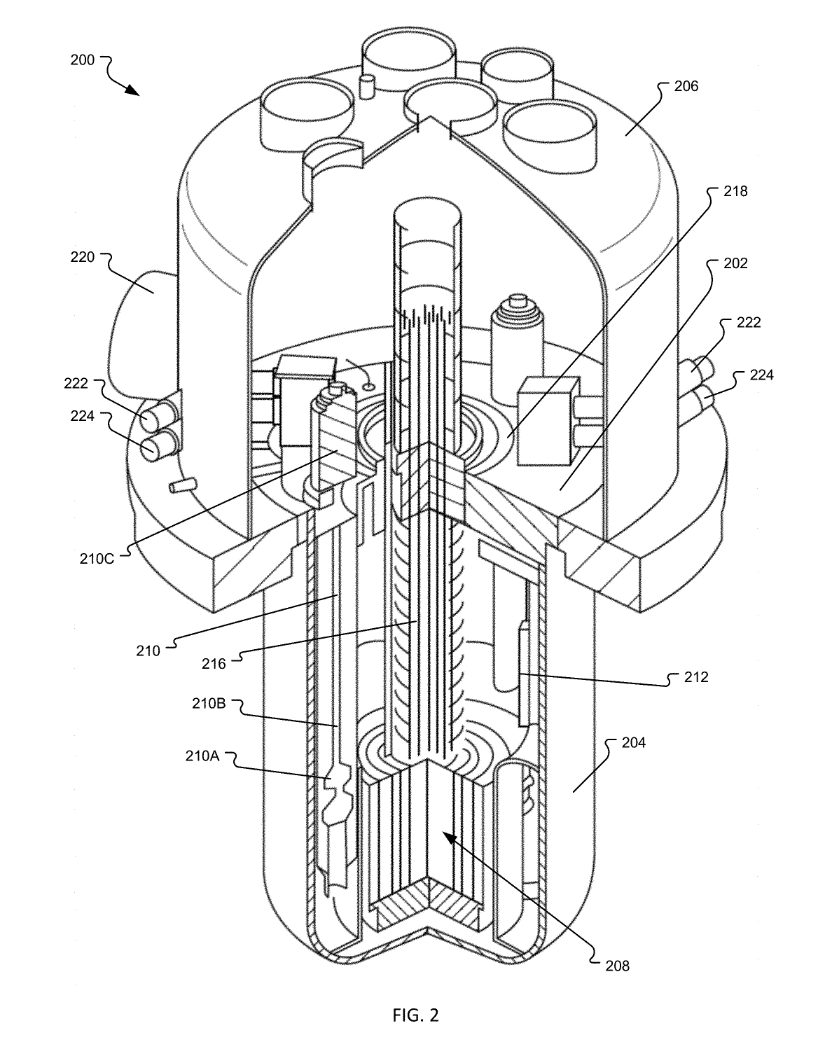

The steel embodiments described above were selected based on a thermodynamic analysis of a range of initial steels of various compositions. The initial steels subjected to analysis are presented in FIG. 1. The initial steels were analyzed to examine each element's effect on such properties as carbonitride structure and stability, grain structure, secondary phase formation, impact toughness, and creep strength. The steel embodiments described above were identified based on the analysis as particularly suitable to use in high temperature, high radiation environments, such as for components in the traveling wave reactor of FIG. 2, which is described in greater detail below.

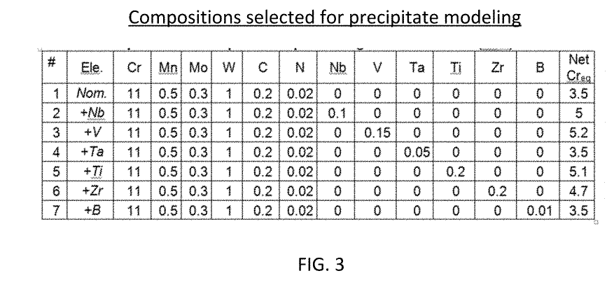

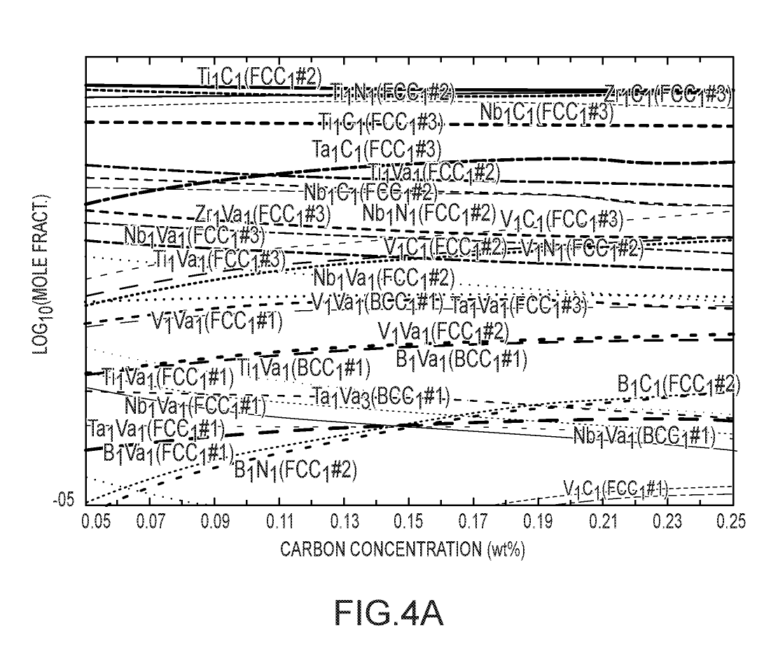

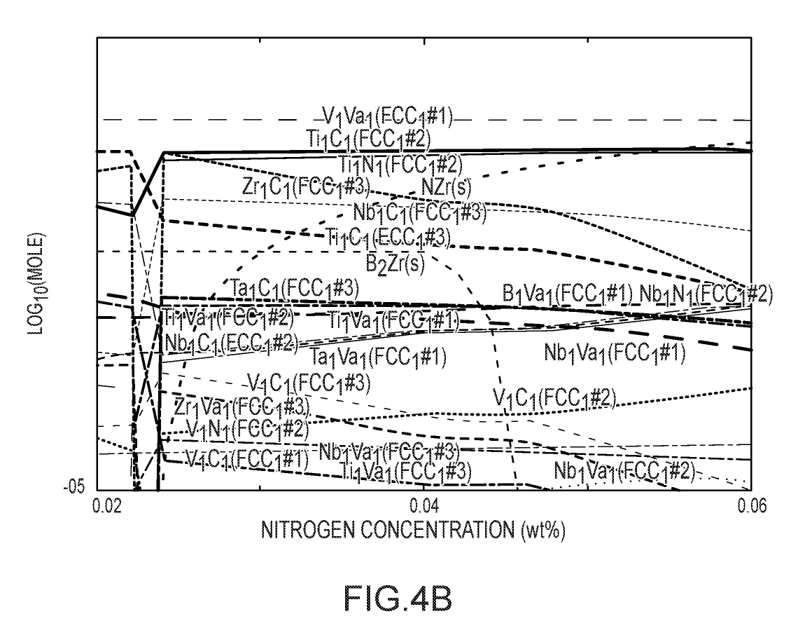

Based on the results of the thermodynamic analysis, the compositions listed in FIG. 3 were then selected for further study of the precipitate phases. Changes in precipitate phases were explored as a function of both carbon concentration and also nitrogen concentration. FIGS. 4A and 4B are sample results from the precipitate phase study. FIG. 4A shows the mole fraction of carbonitride phases for all solute additions as a function of increasing C concentration at 1075° C. for an 11.0 wt. % Cr embodiment of the steel described herein. FIG. 4B shows the mole fraction of carbonitride phases for all solute additions as a function of increasing N concentration at 1075° C. for the same embodiment as FIG. 4A.

Based on both literature review and thermodynamic modeling described above, the steel embodiments presented in Tables 1 and 2 were identified as likely to exhibit improved creep strength, impact toughness, fracture toughness, and swelling resistance at high temperatures and doses. For the purposes of this disclosure, determination of swelling may be performed using the technique described in M. B. Toloczko and F. A. Garner, “Irradiation creep and void swelling of two LMR heats of HT9 at ˜400 C and 165 dpa”, Journal of Nuclear Materials, 233-237 (1996) 289-292. Fracture toughness may be determined by ASTM E 1820, “Standard Test Method for Measurement of Fracture Toughness.” Creep testing may be performed by ASTM E139-11, “Standard Methods for Conducting Creep, Creep-Rupture, and Stress-Rupture Tests of Metallic Materials.” Impact toughness may be measured using ASTM E23-12c, “Standard Methods for Notched Bar Impact Testing of Metallic Materials.”

For example, one or more embodiments of the steels described herein are expected to have a fracture toughness of greater than 100 MegaPascal-square root meter (MPa m^{0.5}) and should resist change over time when exposed to radiation at high temperatures of up to 700° C.), thermal creep rupture strength of more than or equal to 92 MPa at 600° C. and 10⁵ hr and more than or equal to 43 MPa at 650° C. at 10⁵ hr; and/or swelling of less than 5% by volume after neutron doses of 500 dpa. In particular, embodiments that in fracture toughness testing at elevated temperatures up to 700° C. exhibit only ductile tearing and no brittle fracture are anticipated.

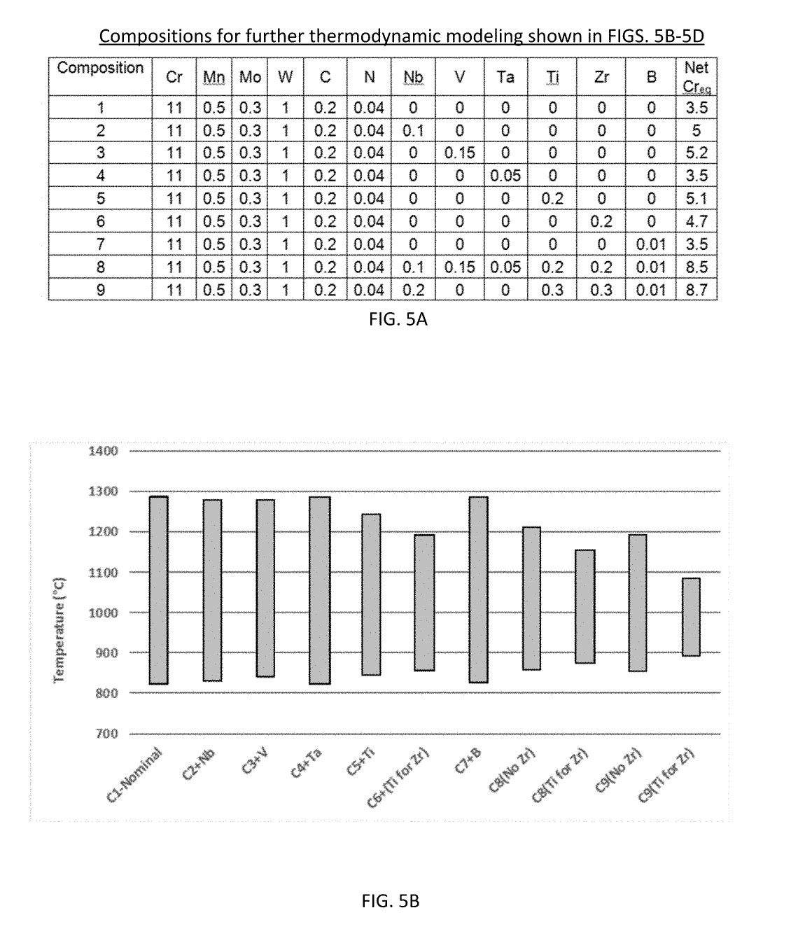

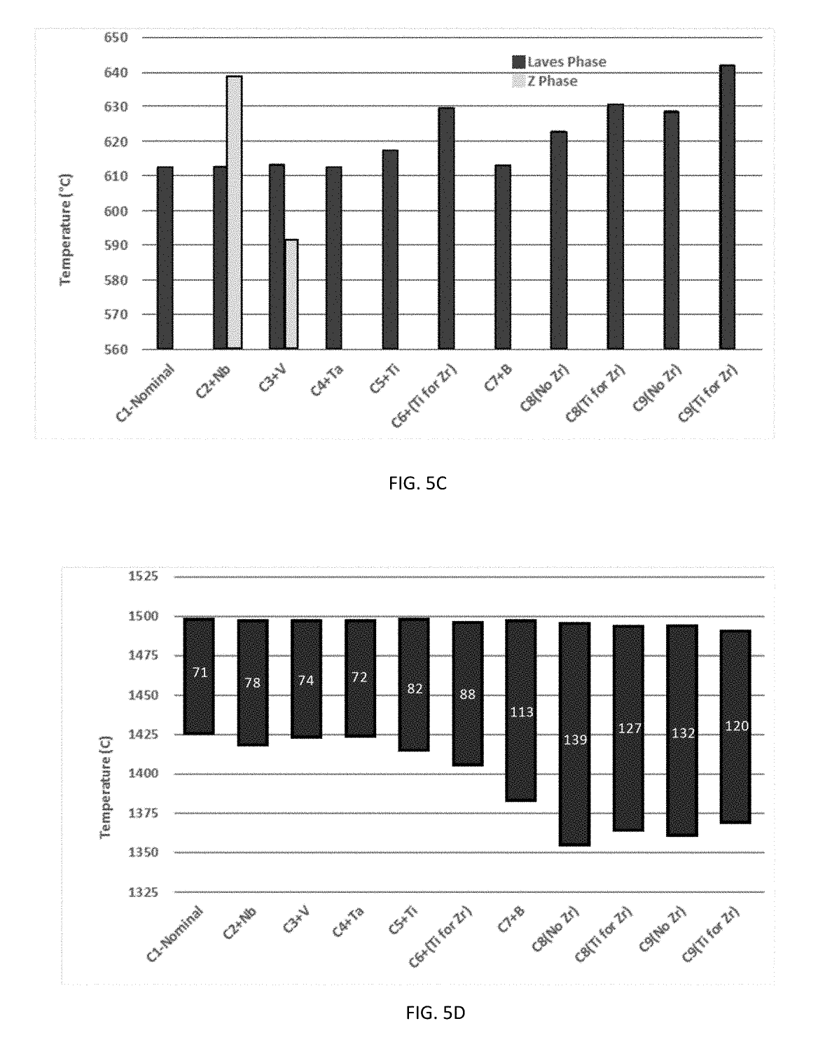

FIGS. 5A-5D illustrate results of additional thermodynamic calculations on various steel embodiments. FIG. 5A lists the specific embodiments used in these calculations. FIG. 5B shows the estimated temperature ranges of 100% austenite stability. FIG. 5C shows a comparison of the temperatures below which Laves phase and Z phase are stable for the given alloys. FIG. 5D shows a comparison of the thermodynamic melting ranges of the selected alloys.

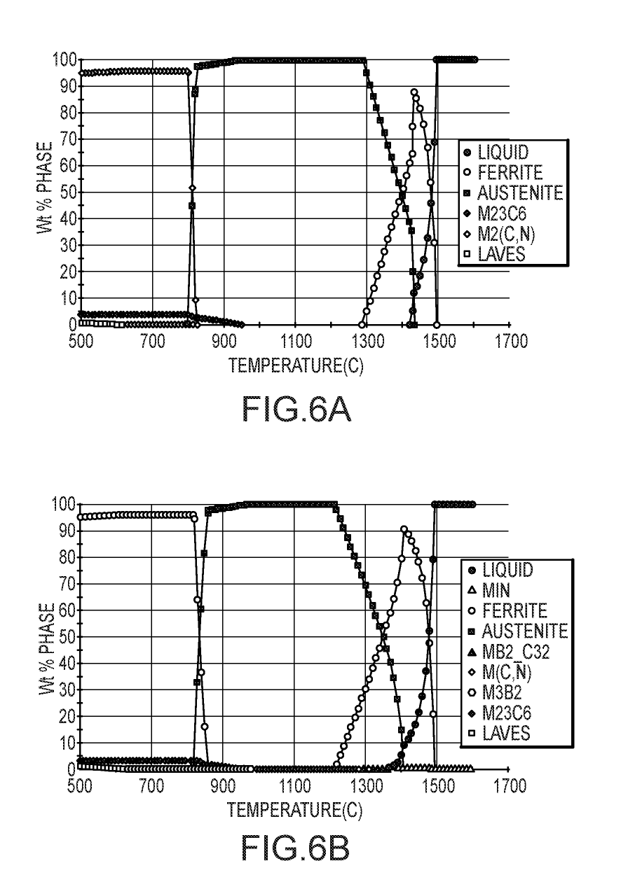

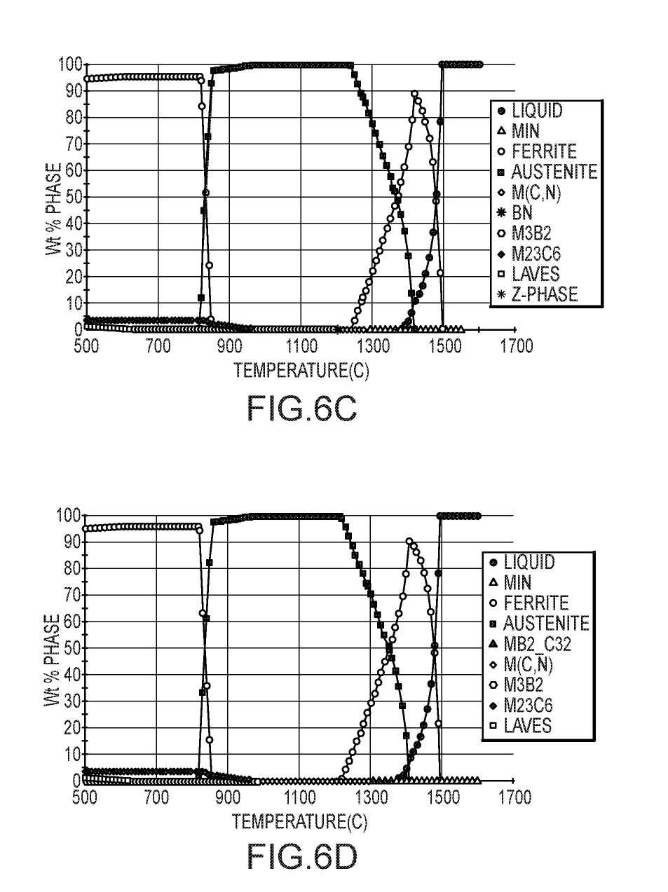

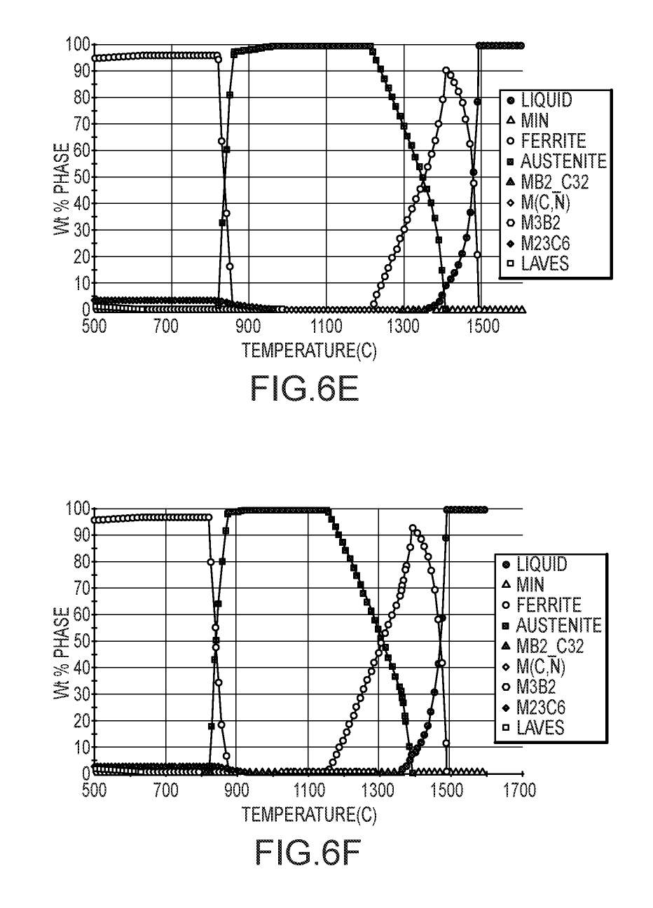

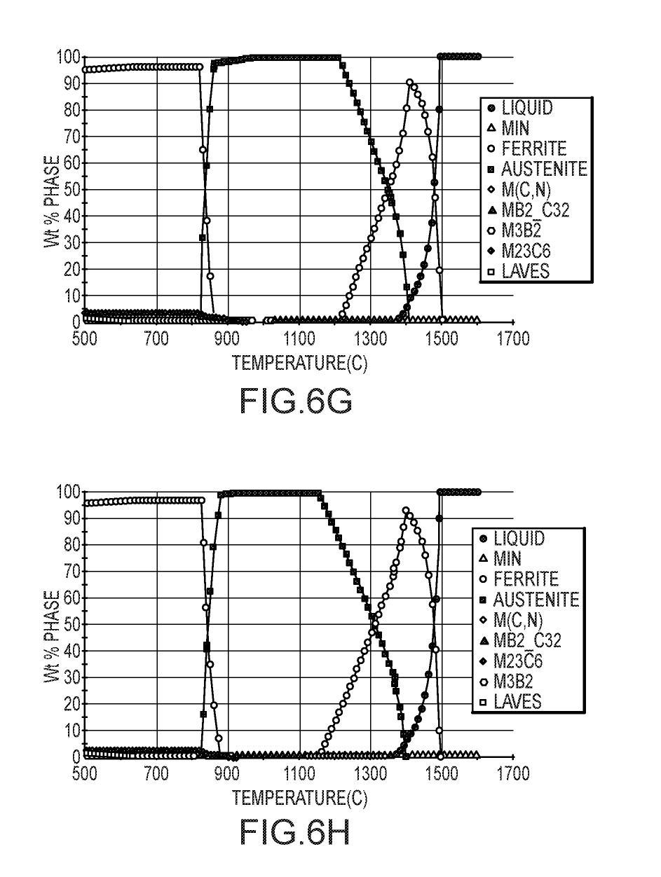

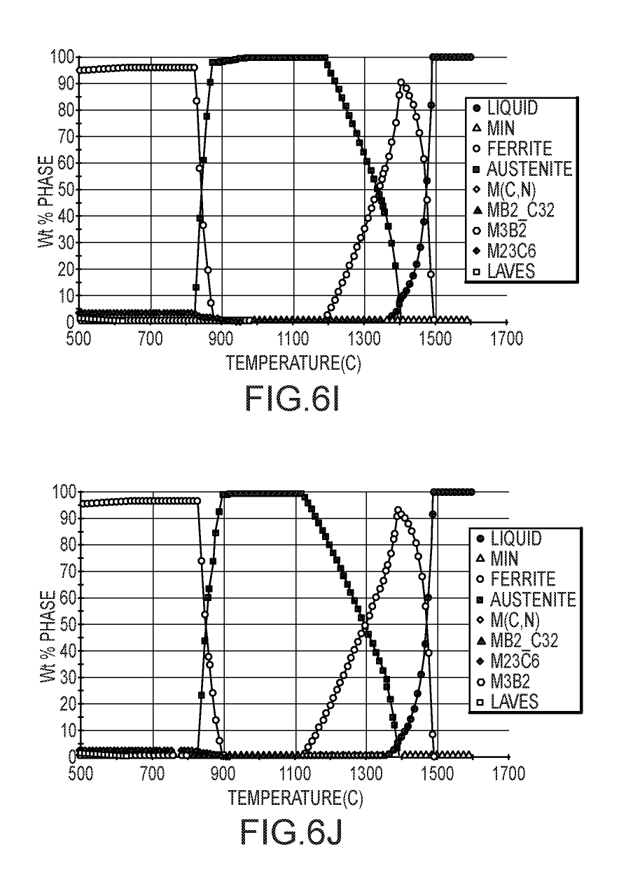

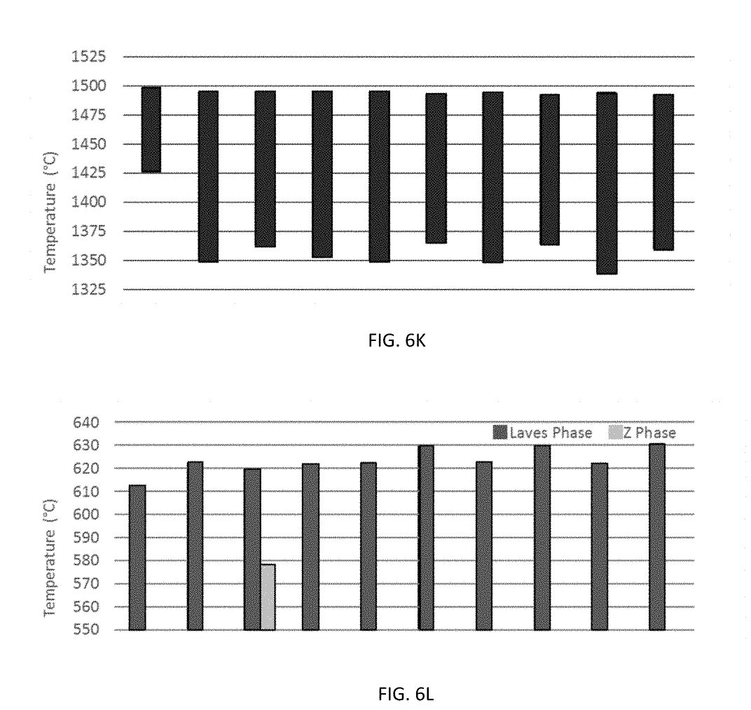

FIGS. 6A-6L are thermodynamic predictions for different embodiments of the steel as described herein. FIG. 6K shows the comparison of the predicted thermodynamic melting ranges for different steel embodiments. FIG. 6L shows the predicted temperature below which Laves phase is stable for the same steel embodiments as in FIG. 6K.

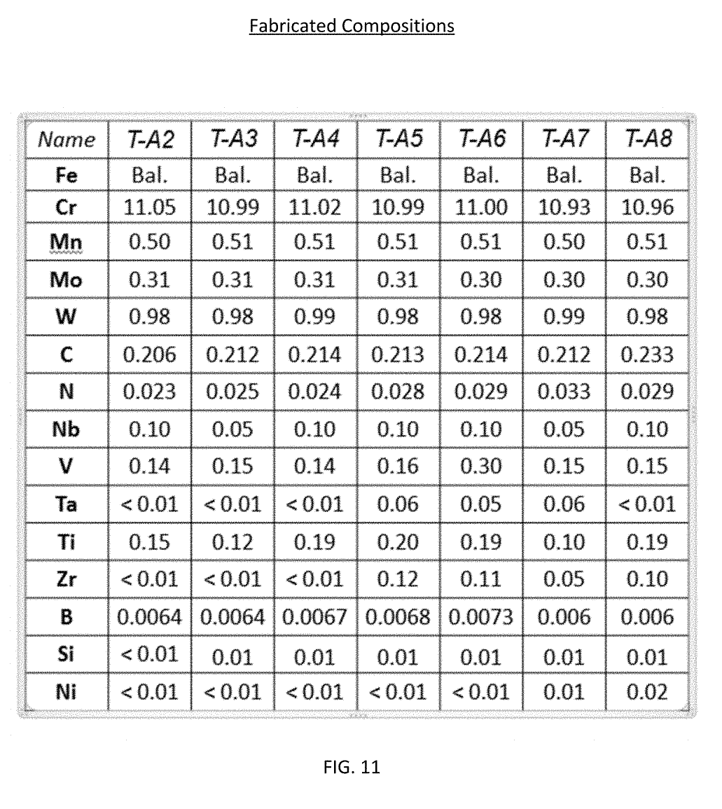

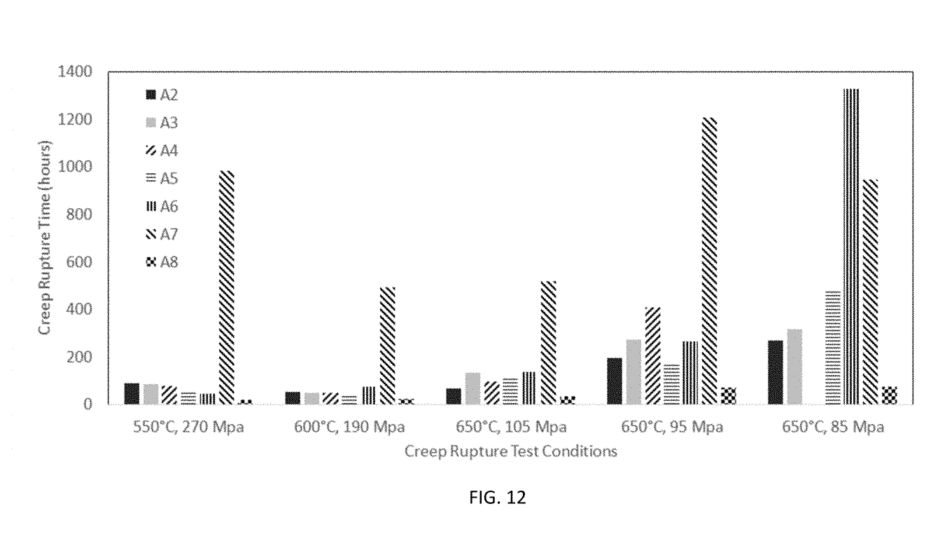

Based on the modeling, seven embodiments of the steels, designated T-A2 through T-A8 where manufactured and tested for creep rupture performance. FIG. 11 presents the compositions of the fabricated embodiments and FIG. 12 presents the creep rupture test results. Note that the steel names in FIG. 11 for the fabricated embodiments have no correspondence to the names in TABLES 1 or 2.

Without being bound to any particular theory, it appears from the performance that small but controlled amounts of Nb, V, Ta, Ti, Si, and Zr have some synergistic effect on the performance of the steel as can be seen when comparing T-A7 to TAB, for instance.

### Manufacture

The following is an embodiment for the manufacture of heats of the steel embodiments described above, including the fabricated embodiments. First, the compositions of the steel embodiment are combined and cast into one or more ingots or slabs. This may be done using any suitable technique such as using vacuum induction melting (VIM) or argon-oxygen decarburization (AOD) followed by VIM. Further refining to reduce impurities may or may not be performed, for example by vacuum arc re-melting (VAR) or electro-slag re-melting (ESR) or consumable electrode vacuum arc re-melting (CEVAR). One might also follow VIM with inert gas atomization for powder fabrication in order to use the steel in powder metallurgy applications. The ingots or slabs are then homogenized for some period of time at a temperature above the austenitic temperature of the composition. For example, ingots may be homogenized for 48 hours at 1125° C. (+/−10° C.). Homogenization may be performed in a reducing environment to minimize oxidation and decarburization (and loss of steel product). After homogenization, ingots or slabs may be hot forged to bar and the forged bar may then be annealed for softening for a set period of time at an annealing temperature. In an embodiment, annealing may be performed at 780° C. for 1 hour. The annealing may further be performed in a vacuum furnace, a reducing environment or with an inert cover to minimize oxidation. A forged bar may then be machined to remove any oxide. After hot forging, cold work may be introduced using cold rolling. One may also employ pilgering to introduce cold work.

The following is an embodiment of a method of cold rolling and heat treatment of the steel embodiments. Heats of a steel embodiment, regardless of form (e.g., bar, slab, sheet, etc.), may first be cold worked using a cold rolling mill. One or more passes may be used to work the heat into a desired form. Optionally, intermediate annealing operations, as described above, may be performed as needed, such as at between 680-800° C. for 0.5-1.5 hours to maintain the softness of the heat. After cold rolling, heats of the steel embodiment may be normalized. Normalization may be performed in a vacuum furnace, a reducing environment, or with an inert cover gas, in order to minimize oxidation. Normalization may be performed by heating the heats to between 1000-1250° C. for between five minutes and 1 hour. For example, in an embodiment normalization is performed by heating to 1075-1150° C. for from 10-30 minutes. Following normalization, the heats may be tempered at 700° C. for 1 hour in a vacuum furnace or an argon environment in order to minimize oxidation. Cooling rates should be sufficient to form 99-100% martensite after normalization. This may be achieved by an air cool, a water quench, a salt bath quench, or some other means of rapidly cooling the steel after normalization to form martensite. For thick section components, a water or salt bath quench may be necessary to cool the steel at a sufficient rate to form martensite.

In an embodiment, the method includes hot forging a large billet (˜6″ diameter, but other sizes could be used), then gun drilling a center cylindrical hole through the billet. The billet is then heated to high temperatures (e.g., 1000-1150° C.). The hot billet is then passed through an extrusion press to form a tube.

### INDUSTRIAL USES

The steel embodiments described herein are suitable for any uses in which high temperature performance is beneficial. In addition, uses where swelling resistance, creep strength and fracture toughness are beneficial would also be suitable for the steels described herein. In particular, steel embodiments described above may have improved performance for any use in which the steel is exposed to nuclear radiation. For example, reactor core components, containment vessels, piping, and structure supports are examples of high-temperature uses of the steels described herein.

One particular use of the steel embodiments described herein is as cladding material for nuclear fuel. Fuel cladding refers to the outer layer of fuel elements (sometimes also called “fuel rods” or “fuel pins”). Cladding prevents fission products from escaping from the fuel into the reactor. Steels developed for nuclear fuel cladding are exposed to high neutron fluxes and high temperatures and therefore have several common requirements: good swelling resistance, high irradiation plus thermal creep strength, and excellent phase stability. Void swelling is the tendency for vacancy defects to accumulate into nanometer-scale cavities that can result in bulk dimensional changes (swelling) to a component. These changes can become significant enough to impair component functionality. Irradiation creep, meanwhile, is similar to thermal creep in that the applied stress is the driving force for the defect flux. However, the source of defects is produced by irradiation and does not directly depend on temperature, and irradiation creep is generally accepted to be linearly dependent with stress. The effect of irradiation creep is the same as thermal creep, however, with creep deformation resulting in dimensional changes.

An example of the need to withstand high neutron fluxes is illustrated by the behavior of austenitic stainless steels, such as the common grades of 304 and 316. While these steels have long seen application in reactor environments, the solution-annealed condition was quickly recognized as deficient for most reactor applications, as void swelling rates can be as high as 1% per displacement per atom even after short irradiation times resulting in only a few displacements per atom (dpa). Irradiation dose in a material is measured in dpa, which is a measure of the number of times every atom in a material has been knocked off its lattice site. While many improvements have been made to the austenitic stainless steels to improve swelling resistance, for high dose applications, they are unable to maintain dimensional stability and meet performance requirements for fuel cladding at very high doses. Since most atoms quickly return to their lattice site without lasting damage, an atom can be displaced multiple times on average before bulk properties are significantly degraded. A modified austenitic stainless steel such as D9 (316+Ti and other solute additions, always fabricated in the 20% cold worked condition) can even withstand about 100 dpa of irradiation damage before bulk swelling is severely limiting.

Many modern reactor designs, however, would benefit from fuel cladding having improved performance over those made of modified austenitic stainless steels. In an embodiment, reactor core components, and specifically fuel cladding, which can withstand peak irradiation doses on the order of 200, 300, 400, or 500 dpa or more would be beneficial. At the moment, there are currently no such steels available and, thus, reactor design is limited in order to account for the lower performance of the currently available steels. For example, embodiments of the steels described herein may have sufficient creep resistance at nominal reactor outlet temperatures of 550° C. or even higher for the steel to remain in service for fuel lifetimes up to 40 years or longer. Likewise, embodiments may have similarly improved swelling resistance, exhibiting a volumetric swelling of 5% or less for fuel lifetimes up to 40 years or longer, and sufficient fracture toughness to resist fracture or failure after irradiation at temperatures of up to 360° C.

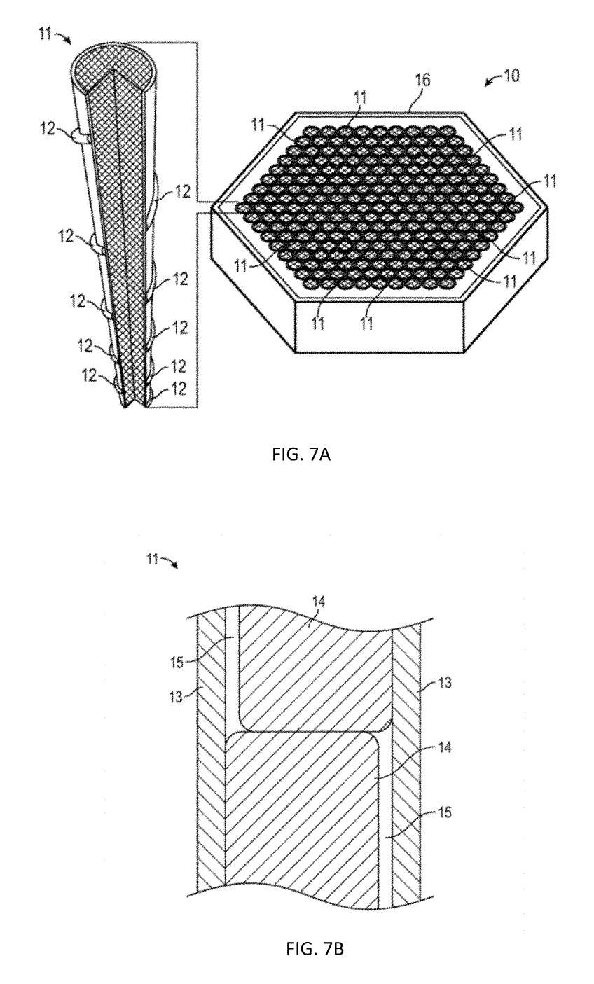

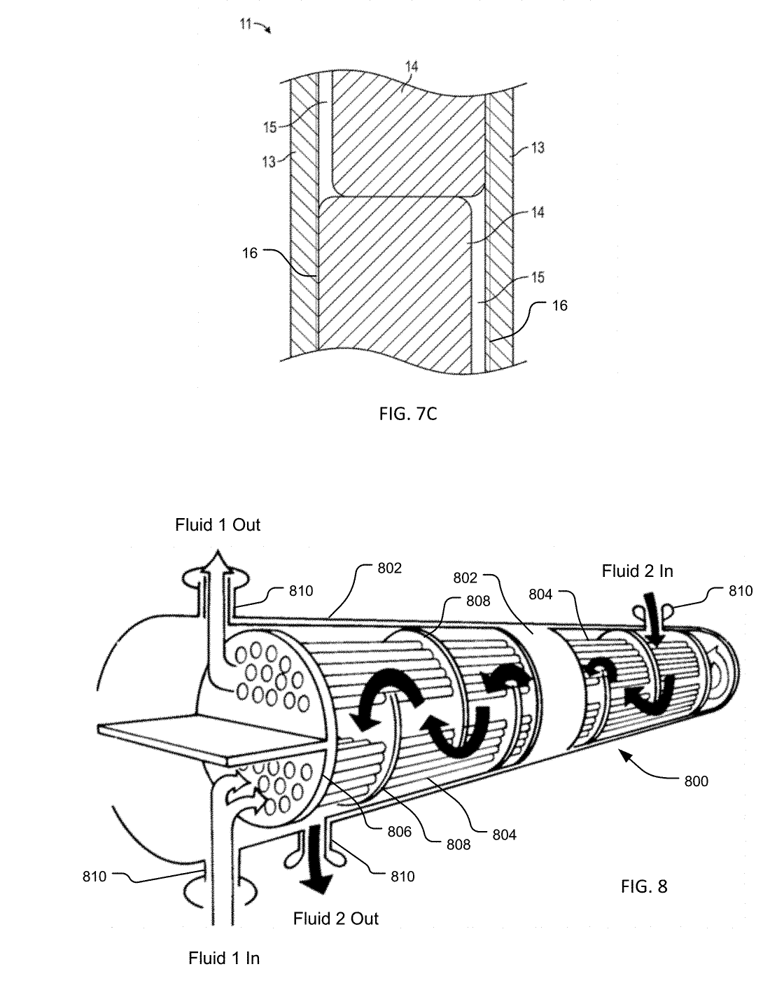

FIG. 7A provides partial-cutaway perspective views in schematic form of an embodiment of a nuclear fuel assembly comprised of multiple fuel elements. FIG. 7A provides a partial illustration of a nuclear fuel assembly 10 in accordance with one embodiment. The fuel assembly may be a fissile nuclear fuel assembly or a fertile nuclear fuel assembly. The assembly may include fuel elements (or “fuel rods” or “fuel pins”) 11. FIG. 7B provides a partial illustration of a fuel element 11 in accordance with one embodiment. As shown in this embodiment, the fuel element 11 may include a cladding material 13, a fuel 14, and, in some instances, at least one gap 15.

A fuel may be sealed within a cavity by the exterior cladding material 13. In some instances, the multiple fuel materials may be stacked axially as shown in FIG. 1 (b), but this need not be the case. For example, a fuel element may contain only one fuel material. In one embodiment, gap(s) 15 may be present between the fuel material and the cladding material, though gap(s) need not be present. In one embodiment, the gap is filled with a pressurized atmosphere, such as a pressured helium atmosphere. In an additional embodiment, the gap may be filled with sodium.

A fuel may contain any fissionable material. A fissionable material may contain a metal and/or metal alloy. In one embodiment, the fuel may be a metal fuel. It can be appreciated that metal fuel may offer relatively high heavy metal loadings and excellent neutron economy, which is desirable for breed-and-burn process of a nuclear fission reactor. Depending on the application, fuel may include at least one element chosen from U, Th, Am, Np, and Pu. The term “element” as represented by a chemical symbol herein may refer to one that is found in the Periodic Table—this is not to be confused with the “element” of a “fuel element”.

FIG. 7C illustrates an embodiment of a fuel element in which one or more liners are provided between the cladding and the fuel. In some cases, particularly at high burn-ups, the elements of the fuel and the cladding may tend to diffuse, thereby causing un-desirable alloying and thus degrading the material of the fuel and the cladding (e.g., by de-alloying of the fuel and/or cladding layer or forming a new alloy with degraded mechanical properties). A liner 16 as illustrated may serve as a barrier layer between the fuel 14 and the cladding 13 to mitigate such interatomic diffusion of the elements. For example, a liner 16 may be employed to mitigate interatomic diffusion between the elements of the fuel and the cladding material to avoid, for example, degradation of the fuel and/or cladding material by foreign (and sometimes undesirable) elements. The liner 16 may contain one layer or multiple layers—e.g., at least 2, 3, 4, 5, 6, or more layers. In the case where the liner contains multiple layers, these layers may contain the same or different materials and/or have the same or different properties. For example, in one embodiment, at least some of the layers may include the same steel as the cladding while some layers of the liner 16 include different materials.

Heat exchanger shells, tubes, and tube sheets are another example of process equipment components that could be manufactured out of the steel embodiments described above. FIG. 8 illustrates a shell and tube heat exchanger configured with a shell. The exchanger 800 includes a shell 802, a set of U-shaped tubes 804, a tube sheet 806, a number of baffles 808 and various access ports 810. Any and all of these components could be manufactured from the high temperature, radiation-resistant steel embodiments described above. In addition, FIG. 8 is but one type of heat exchanger and the steel embodiments disclosed herein are suitable for any heat exchanger design such as, for example, air-cooled heat exchangers, double-pipe heat exchangers, and plate-and-frame heat exchangers.

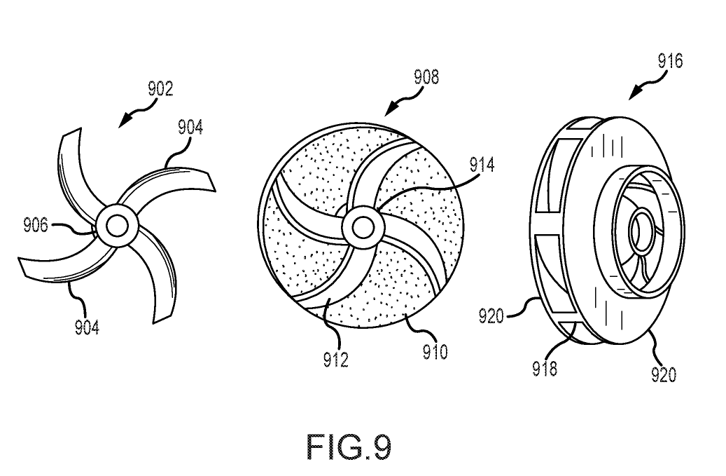

Pump impellers are another example of a piece of process equipment that could be manufactured out of the steel embodiments described above. In some nuclear reactor designs, pump impellers may be within a reactor core and subjected to high doses of radiation. FIG. 9 illustrates embodiments of open, semi-open and closed impellers. The open impeller 902 consists only of blades 904 attached to a hub 906. The embodiment of the semi-open impeller 908 is constructed with a circular plate 910 attached to one side of the blades 912 and hub 914. The closed impeller 916 has circular plates 920 attached on both sides of the blades 918. FIG. 9 illustrates only a few representative embodiments of impeller designs, but it will be understood that the steel embodiments disclosed herein are suitable for any impeller design such as, for example, vortex impellers, centrifugal screw impellers, propellers, shredder impellers, closed channel impellers, mixed flow impellers, radial impellers, semiaxial impellers and axial impellers.

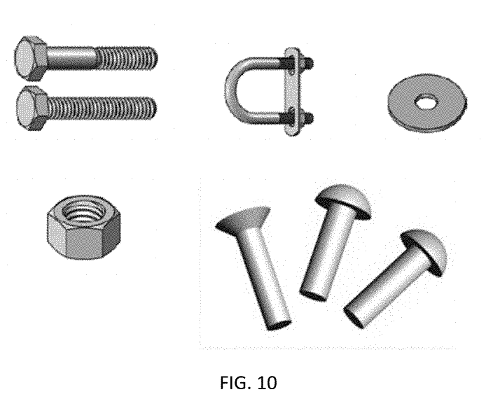

Structural members and fasteners are yet other examples of components that could be manufactured out of the steel embodiments described above. Nuts, bolts, U-bolts, washers, and rivets, examples of which are shown in FIG. 10, made of the steel embodiments disclosed herein would be particularly useful in high temperature environments and also in high radiation dose environments.

FIG. 2 illustrates an embodiment of a traveling wave reactor as is known in the art. FIG. 2 identifies many of the main components of the traveling wave reactor 200, such as the reactor head 202, reactor and guard vessel 204, and containment dome 206 but also illustrates many ancillary reactor components such as structural members, flanges, cover plates, piping, railing, framing, connecting rods, and supports. Any of the reactor components illustrated in FIG. 2, and especially those components located within the reactor core, could be manufactured out of the steel embodiments described above.

The traveling wave reactor 200 is designed to hold a number of nuclear fuel pins in a reactor core 208 located at the bottom of the reactor and guard vessel 204. The reactor head 202 seals the radioactive materials within the reactor and guard vessel 204. In the embodiment shown the reactor core 208 can only be accessed through the reactor head 202. For example, an in-vessel fuel handling machine 216 is provided. The fuel handling machine 216 allows fuel pins and other instruments to be lifted from the core and removed from the vessel via a set of large and small rotating plugs 218 located in the reactor head 202. This design allows the vessel 204 to be unitary and without any penetrations.

A thermal shield may also be provided beneath the reactor head 202 to reduce the temperature in the area in the containment dome 206 above the reactor head 202. This area may be accessed by a hatch 220 as shown. Additional access hatches may also be provided in different locations within containment dome 206 as shown.

Sodium, which is a liquid at operating temperatures, is the primary coolant for removing heat from the reactor core 208. The reactor and guard vessel 204 is filled to some level with sodium which is circulated through the reactor core 208 using pumps 210. Two sodium pumps 210 are provided. Each pump 210 includes an impeller 210A located adjacent to the reactor core 208, connected by a shaft 210B which extends through the reactor head 202 to a motor 210C located above the reactor head 202.

The pumps 210 circulate the sodium through one or more intermediate heat exchangers 212 located within the reactor and guard vessel 204. The intermediate heat exchangers 212 transfers heat from the primary sodium coolant to a secondary coolant. Fresh secondary coolant is piped through the containment dome 206 (via one or more secondary coolant inlets 222) and the reactor head 202 to the intermediate heat exchangers 212 where it is heated. Heated secondary coolant then flows back through the reactor head 202 and out the containment dome 206 in one or more secondary coolant outlets 224. In an embodiment, the heated secondary coolant is used to generate steam which transferred to a power generation system. The secondary coolant may be a sodium coolant or some other salt coolant such as a magnesium sodium coolant.

Notwithstanding the appended claims, the disclosure is also defined by the following clauses:
1. A steel consisting of:
10.0-12.0 wt. % Cr;
0.001-1.0 wt. % Mn;
0.001-2.0 wt. % Mo;
0.001-2.5 wt. % W;
0.1-0.3 wt. % C;
up to 0.1 wt. % N;
up to 0.2 wt. % Nb;
up to 0.5 wt. % V;
up to 0.2 wt. % Ta;
up to 0.3 wt. % Ti;
up to 0.3 wt. % Zr;
up to 0.1 wt. % B;
the balance being Fe and other elements, wherein the steel includes not greater than 0.15 wt. % of each of these other elements, and wherein the total of these other elements does not exceed 0.35 wt. %.
2. The steel of clause 1 wherein the steel includes 10.0-11.0 wt. % Cr.
3. The steel of clause 1 wherein the steel includes 10.5-11.5 wt. % Cr.
4. The steel of any one of the above clauses wherein the steel includes 0.20-0.80 wt. % Mn.
5. The steel of any one of the above clauses wherein the steel includes 0.40-0.60 wt. % Mn.
6. The steel of any one of the above clauses wherein the steel includes 0.20-1.0 wt. % Mo.
7. The steel of any one of the above clauses wherein the steel includes 0.45-0.55 wt. % Mo.
8. The steel of any one of the above clauses wherein the steel includes 0.50-1.5 wt. % W.
9. The steel of any one of the above clauses wherein the steel includes 0.90-1.1 wt. % W.
10. The steel of any one of the above clauses wherein the steel includes 0.15-0.25 wt. % C.
11. The steel of any one of the above clauses wherein the steel includes 0.18-0.22 wt. % C.
12. The steel of any one of the above clauses wherein the steel includes 0.01-0.08 wt. % N.
13. The steel of any one of the above clauses wherein the steel includes 0.03-0.05 wt. % N.
14. The steel of any one of the above clauses wherein the steel includes 0.02-0.20 wt. Nb.
15. The steel of any one of the above clauses wherein the steel includes 0.03-07 wt. Nb.
16. The steel of any one of the above clauses wherein the steel includes 0.10-0.50 wt. % V.
17. The steel of any one of the above clauses wherein the steel includes 0.28-0.32 wt. % V.
18. The steel of any one of the above clauses wherein the steel includes 0.01-0.20 wt. % Ta.
19. The steel of any one of the above clauses wherein the steel includes 0.04-0.06 wt. % Ta.
20. The steel of any one of the above clauses wherein the steel includes 0.05-0.30 wt. % Ti.
21. The steel of any one of the above clauses wherein the steel includes 0.05-0.10 wt. % Ti.
22. The steel of any one of the above clauses wherein the steel includes 0.05-0.30 wt. % Zr.
23. The steel of any one of the above clauses wherein the steel includes 0.05-0.10 wt.
% Zr.
24. The steel of any one of the above clauses wherein the steel includes 0.001-0.02 wt. % B.
25. The steel of any one of the above clauses wherein the steel includes 0.007-0.009 wt. % B.
26. The steel of any one of the above clauses wherein one of the other elements in the steel is S and the steel includes up to 0.010 wt. % S.
27. The steel of any one of the above clauses wherein one of the other elements in the steel is P and the steel includes up to 0.040 wt. % P.
28. The steel of any one of the above clauses wherein one of the other elements in the steel is Cu and the steel includes up to 0.04 wt. % Cu.
29. The steel of any one of the above clauses wherein one of the other elements in the steel is Co and the steel includes up to 0.050 wt. % Co.
30. The steel of any one of the above clauses wherein one of the other elements in the steel is As and the steel includes up to 0.030 wt. % As.
31. The steel of any one of the above clauses wherein one of the other elements in the steel is Si and the steel includes from 0.05-0.2 wt. % Si.
32. The steel of any one of the above clauses wherein one of the other elements in the steel is Ni and the steel includes up to 0.05 wt. % Ni.
33. A component made of the steel of any one of the above clauses.
34. A cladding for nuclear fuel made of the steel of any one of clauses 1-32.
35. A heat exchanger comprising a shell, a plurality of tubes, and a tube sheet, wherein at least one of the shell, tubes or tube sheet are made of the steel of any one of clauses 1-32.
36. A pump impeller made of the steel of any one of clauses 1-32.
37. A fastener made of the steel of any one of clauses 1-32.
38. A traveling wave reactor including at least one component made of the steel of any one of clauses 1-32.
39. A steel exhibiting one or more of: a fracture toughness of greater than 100 MegaPascal-square root meter (MPa m^{0.5}); a thermal creep of less than or equal to 71 MPa at 593° C. and 10⁴ hr and less than or equal to 30 MPa at 649° C. at 10⁵ hr; and a swelling of less than 5% by volume after neutron doses of 500 dpa.

Concentrations, amounts, and other numerical data have been expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “4 percent to 7 percent” should be interpreted to include not only the explicitly recited values of 4 percent to 7 percent, but also include individual values and sub-ranges within the indicated range. Thus, included in this numerical range are individual values such as 4.5, 5.25 and 6 and sub-ranges such as from 4-5, from 5-7, and from 5.5-6.5; etc. This same principle applies to ranges reciting only one numerical value. Ranges when specified in the format 9.0-12.0 are inclusive of the limits of the range (i.e., 9.0-12.0 includes compositions having 9.0 and compositions having 12.0). Furthermore, such an interpretation should apply regardless of the breadth of the range or the characteristics being described.

Notwithstanding that the numerical ranges and parameters setting forth the broad scope of the technology are approximations, the numerical values set forth in the specific examples are reported as precisely as possible. Any numerical value, however, inherently contains certain errors necessarily resulting from the standard deviation found in their respective testing measurements.

It will be clear that the systems and methods described herein are well adapted to attain the ends and advantages mentioned as well as those inherent therein. While various embodiments have been described for purposes of this disclosure, various changes and modifications may be made which are well within the scope contemplated by the present disclosure. For example, an embodiment such as 10.5-11.5 wt. % Cr, 0.4-0.6 wt. % Mn, 0.25-0.35 wt. % Mo, 0.9-1.1 wt. % W, 0.18-0.22 wt. % C, 0.03-0.05 wt. % N, 0.08-0.12 wt. % Nb, 0.28-0.32 wt. % V, and less than 0.01 wt. % of each of Ta, Ti, Zr and B (balance Fe, of course) is explicitly contemplated, even though it is not listed in Tables 1 or 2. Numerous other changes may be made which will readily suggest themselves to those skilled in the art and which are encompassed in the spirit of the disclosure.

What is claimed is:

1. A steel consisting of:
10.0-12.0 wt. % Cr;
0.001-1.0 wt. % Mn;
0.001-2.0 wt. % Mo;
0.001-2.5 wt. % W;
0.1-0.3 wt. % C;
up to 0.1 wt. % N;
up to 0.2 wt. % Nb;
up to 0.5 wt. % V;
up to 0.2 wt. % Ta;
up to 0.3 wt. % Ti;
up to 0.3 wt. % Zr;
up to 0.1 wt. % B;
the balance being Fe and other elements, wherein the steel includes not greater than 0.15 wt. % of each of these other elements, and wherein the total of these other elements does not exceed 0.35 wt. %.

2. The steel of claim 1 wherein the steel includes 10.0-11.0 wt. % Cr.

3. The steel of claim 1 wherein the steel includes 10.5-11.5 wt. % Cr.

4. The steel of claim 1 wherein the steel comprises:
0.20-0.80 wt. % Mn;
0.20-1.0 wt. % Mo;
0.50-1.5 wt. % W;
0.15-0.25 wt. % C;
0.01-0.08 wt. % N;
0.02-0.20 wt. % Nb;
0.10-0.50 wt. % V;
0.01-0.20 wt. % Ta;
0.05-0.30 wt. % Ti;
0.05-0.30 wt. % Zr; and
0.001-0.02 wt. % B.

5. The steel of claim 3 wherein the steel comprises:
0.40-0.60 wt. % Mn;
0.45-0.55 wt. % Mo;
0.90-1.1 wt. % W;
0.18-0.22 wt. % C;
0.03-0.05 wt. % N;
0.03-07 wt. % Nb;
0.28-0.32 wt. % V;
0.04-0.06 wt. % Ta;
0.05-0.10 wt. % Ti;
0.05-0.10 wt. % Zr; and
0.007-0.009 wt. % B.

6. The steel of claim 1 wherein one of the other elements in the steel is S and the steel includes up to 0.010 wt. % S.

7. The steel of claim 1 wherein one of the other elements in the steel is P and the steel includes up to 0.040 wt. % P.

8. The steel of claim 1 wherein one of the other elements in the steel is Cu and the steel includes up to 0.04 wt. % Cu.

9. The steel of claim 1 wherein one of the other elements in the steel is Co and the steel includes up to 0.050 wt. % Co.

10. The steel of claim 1 wherein one of the other elements in the steel is As and the steel includes up to 0.030 wt. % As.

11. The steel of claim 1 wherein one of the other elements in the steel is Si and the steel includes from 0.05-0.2 wt. % Si.

12. The steel of claim 1 wherein one of the other elements in the steel is Ni and the steel includes up to 0.05 wt. % Ni.

13. A radiation-resistant component made of a steel consisting of:
10.0-12.0 wt. % Cr;
0.20-0.80 wt. % Mn;
0.20-1.0 wt. % Mo;
0.50-1.5 wt. % W;
0.15-0.25 wt. % C;
0.01-0.08 wt. % N;
0.02-0.20 wt. % Nb;
0.10-0.50 wt. % V;
0.01-0.20 wt. % Ta;
0.05-0.30 wt. % Ti;
0.05-0.30 wt. % Zr; and
0.001-0.02 wt. % B;
the balance being Fe and other elements, wherein the steel includes not greater than 0.15 wt. % of each of these other elements, and wherein the total of these other elements does not exceed 0.35 wt. %.

14. The radiation-resistant component of claim 13 wherein the steel further comprises:
10.5-11.5 wt. % Cr;
0.40-0.60 wt. % Mn;
0.45-0.55 wt. % Mo;
0.90-1.1 wt. % W;
0.18-0.22 wt. % C;
0.03-0.05 wt. % N;
0.03-07 wt. % Nb;
0.28-0.32 wt. % V;
0.04-0.06 wt. % Ta;
0.05-0.10 wt. % Ti;
0.05-0.10 wt. % Zr; and
0.007-0.009 wt. % B.

15. The radiation-resistant component of claim 13 wherein the component is cladding for nuclear fuel.

16. The radiation-resistant component of claim 13 wherein the component is a heat exchanger component.

17. The radiation-resistant component of claim 13 wherein the component is a pump impeller.

18. The radiation-resistant component of claim 13 wherein the component is a fastener.

19. The radiation-resistant component of claim 13 wherein the component is incorporated into a traveling wave reactor.

20. A steel exhibiting one or more of:
a fracture toughness of greater than 100 MegaPascal-square root meter (MPa m^{0.5});
a thermal creep of less than or equal to 71 MPa at 593° C. and 10⁴ hr and less than or equal to 30 MPa at 649° C. at 10⁵ hr; and
a swelling of less than 5% by volume after neutron doses of 500 dpa.
